(19) United States
(12) Patent Application Publication
(10) Pub. No.: US 2009/0275407 A1
(43) Pub. Date: Nov. 5, 2009

(54) VIRTUALIZATION FOR GAMING DEVICES

(75) Inventors: Anand Singh, Henderson, NV (US); Lawrence McAllister, Las Vegas, NV (US)

Correspondence Address: SEED INTELLECTUAL PROPERTY LAW GROUP, PLLC, 701 FIFTH AVENUE, SUITE 5400, SEATTLE, WA, 98104, US

(73) Assignee: BALLY GAMING, INC., Las Vegas, NV (US)

(21) Appl. No.: 12/113,021

(22) Filed: Apr. 30, 2008

(51) Int. Cl. A63F 13/00; G06F 9/455

(52) U.S. Cl. 463/31; 718/1

(57) ABSTRACT

The resources of a gaming device may be partitioned to create a first virtual machine and a second virtual machine. A first application is executed in a first operating system executing on the first virtual machine, and a second application is executed in a second operating system executing on the second virtual machine.

### BACKGROUND

1. Technical Field

This description generally relates to the field of gaming devices, and more particularly to enabling virtualization within a gaming device.

2. Description of the Related Art

Gaming properties often devote a large percentage of floor space to gaming devices. Each gaming device presents players with individual games of chance, games of skill, or combinations thereof that they may wager on.

In modern gaming properties, many gaming devices comprise general purpose computing devices, and these gaming devices have been subject to ever greater computational demands. Each gaming device may, inter alia: offer a number of graphics-intensive games of chance and associated bonus games to players; communicate via a network with one or more servers within the gaming property; display the content of one or more web pages; receive and process currency of various types inserted by players; display targeted advertisements to players; and process and store information indicative of wagers made by players. As these computational demands have continued to multiply, the computational power provided in each gaming device has similarly increased in order to enable more and more functionality.

However, it would be desirable to provide desired functionality on gaming devices more efficiently.

### BRIEF SUMMARY

In one embodiment, a gaming device is disclosed, the gaming device comprising: a housing; a game display carried by the housing; a user interface carried by the housing and configured to receive user input from a player; a first processor that executes instructions; and a computer-readable memory. The computer-readable memory may have stored thereon: a virtualization module configured to enable access to resources of the gaming device via a first virtual machine and a second virtual machine; a first operating system executable on the first virtual machine; a game of chance executable in the first operating system; a second operating system executable on the second virtual machine; and a real-time application executable in the second operating system, the real-time application being subject to a real-time constraint.

In another embodiment, another gaming device is disclosed, the gaming device comprising: a housing; a game display carried by the housing; a user interface carried by the housing and configured to receive user input from a player; at least one processor that executes instructions; and a computer-readable memory that stores instructions. The instructions stored on the computer-readable memory may cause the at least one processor to enable access to resources of the gaming device, by: partitioning the resources of the gaming device to create a first virtual machine and a second virtual machine; executing a game of chance in a first operating system executing on the first virtual machine; and executing a real-time application subject to a real-time constraint in a second operating system executing on the second virtual machine.

In yet another embodiment, a computer-implemented method of enabling access to resources of a gaming device is disclosed. The method may comprise: partitioning the resources of the gaming device to create a first virtual machine and a second virtual machine; executing a game of chance in a first operating system executing on the first virtual machine; and executing a real-time application subject to a real-time constraint in a second operating system executing on the second virtual machine.

In still another embodiment, a computer-readable medium may store instructions that cause at least one processor to enable access to resources of a gaming device, by: partitioning the resources of the gaming device to create a first virtual machine and a second virtual machine; executing a game of chance in a first operating system executing on the first virtual machine; and executing a real-time application subject to a real-time constraint in a second operating system executing on the second virtual machine.

In yet another embodiment, a computer-implemented method of enabling access to resources of a gaming device is disclosed. The method may comprise: partitioning the resources of the gaming device to create a first virtual machine and a second virtual machine; executing a first application in a first operating system executing on the first virtual machine; and executing a second application in a second operating system executing on the second virtual machine.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a perspective view of a gaming device enabling access to resources via a virtualization module, according to one illustrated embodiment.

FIG. 2 is a high-level schematic view of the gaming device of FIG. 1 showing a plurality of virtual machines, according to one illustrated embodiment.

FIG. 3 is a schematic view of the gaming device of FIG. 1 having two operating systems executing thereon, according to one illustrated embodiment.

FIG. 4 is a schematic view of the gaming device of FIG. 1 having three operating systems executing thereon, according to another illustrated embodiment.

FIG. 5 is a flow diagram illustrating a method for enabling access to resources of a gaming device, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures and methods associated with gaming properties, gaming devices, games of chance, virtualization and virtual machines have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the embodiments.

### Description of an Example Gaming Device

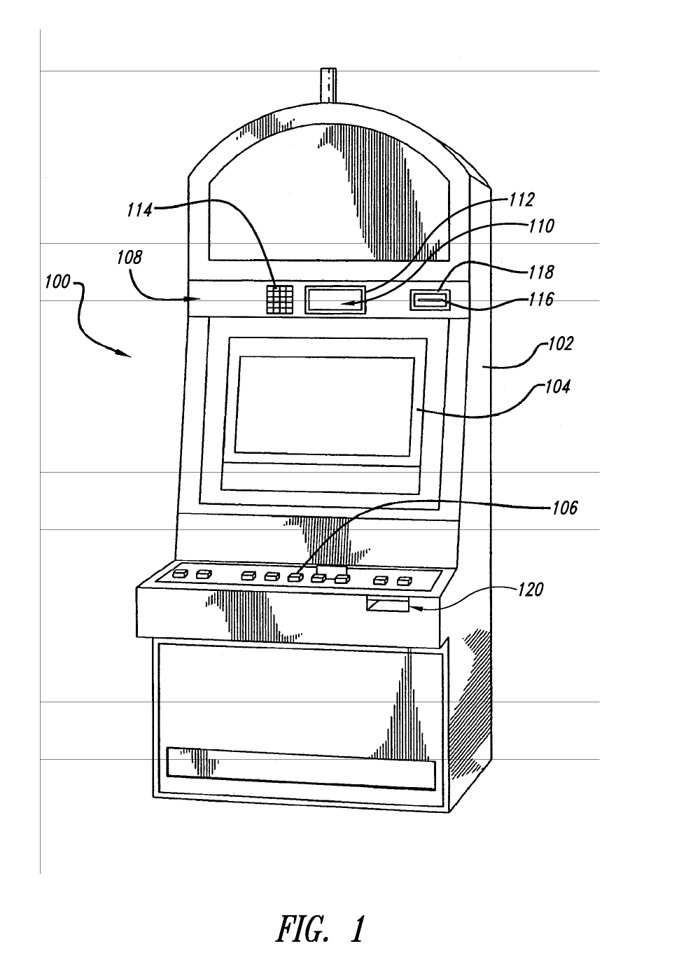

FIG. 1 shows a gaming device 100 configured to enable access to certain resources via a virtualization module. In one embodiment, the virtualization module may enable access to computational resources of the gaming device 100 via a plurality of virtual machines. For example, the virtualization module may logically partition resources of the gaming device 100 to create at least two virtual machines. Thus, in one embodiment, the gaming device 100 may execute a plurality of operating systems substantially concurrently, each of which may utilize the same underlying physical hardware.

As used herein, the term “virtualization” is a general term referring to the process of dividing resources of a computing device into multiple execution environments referred to as “virtual machines,” by applying one or more concepts or technologies such as hardware and software partitioning, time-sharing, partial or complete machine simulation, etc. The resources of the computing device that are divided may include any of the hardware of the computing device, including RAM and other computer-readable memory resources, processing resources, graphics card resources, network bandwidth resources, etc. A number of virtualization technologies have been developed, such as those provided by VMWare® servers and workstations, and XEN® hypervisor. Using these virtualization technologies, each virtual machine acts as a distinct logical computing system. This may allow operating systems and applications running on different virtual machines to operate as though they are the sole programs accessing a given hardware resource, while also providing application isolation and security among the various virtual machines.

The virtualization module may comprise any computer-executable code configured to provide virtualization and is discussed in greater detail below. In one embodiment, the virtualization module may comprise firmware integrated with hardware resources of the gaming device 100 and executable thereon. For example, the virtualization module may be provided as a part of an integrated hardware/firmware solution that may be coupled to other hardware resources of the gaming device 100. In another embodiment, the virtualization module may comprise software that is loadable upon a boot operation into RAM of the gaming device 100 for execution by at least one processor of the gaming device 100. In yet another embodiment, the virtualization module may comprise software that may be executed within an operating system executing on the gaming device 100.

The gaming device 100 may be located within a gaming property (not shown) comprising any of a variety of establishments housing one or more gaming devices used for gaming/gambling. In one embodiment, the gaming device 100 may be located within a casino. However, even convenience stores or gas stations housing the gaming device 100 may be considered a gaming property.

The gaming device 100 may comprise any of a variety of electronic computing devices offering games of chance, games of skill, or combinations thereof that a player may wager on. Such games may include mechanical or video slots, video keno, video poker, video blackjack, Class II bingo, lottery, craps, a mechanical or video representation of a wheel game, etc. One example game of chance is BLAZING 7's, sold by Bally Technologies, Inc. In one embodiment, the gaming device 100 is a single-offering gaming device, enabling play of only one game. However, in other embodiments, the gaming device 100 is relatively flexible, allowing a player to choose from among a number of games.

In the illustrated embodiment, the exterior of the gaming device 100 may be defined by a housing 102. The housing 102 may be a self-standing unit that is generally rectangular in shape. In other embodiments, the housing may comprise a slant-top, bar-top, or table-top style cabinet. Of course, housings of various sizes and shapes may be used in different embodiments of the gaming device 100.

The gaming device 100 may further include a game display 104, operable to present the one or more games of chance or skill described above. In one embodiment, the game display 104 includes a CRT or a panel display, such as, but not limited to, liquid crystal or plasma displays. The game display 104 may also include a touch screen or touch glass system. Thus, the game display 104 may be configured to display a variety of information to a player engaging the gaming device 100 and simultaneously act as a user interface.

The gaming device 100 may further include a variety of other user interfaces via which a player may interact with the gaming device 100. As illustrated, a plurality of player-activated buttons 106 may be provided on a shelf of the housing 102. In one embodiment, a player interaction system 108 may also be provided at the top of the housing 102. This player interaction system 108 may include a graphics display 110, a touch bezel 112, a keypad 114, a player club card reader 116, and a card reader bezel 118.

The graphics display 110 may display a variety of information to a player and may be configured similarly to the game display 104 described above. In one embodiment, the graphics display 110 may display advertisements targeted to a player of the gaming device 100 and/or may provide information regarding gaming rewards available to the player of the gaming device 100. The touch bezel 112 associated with the graphics display 110 and the keypad 114 may comprise user interfaces via which a player may enter information into or otherwise interact with the gaming device 100, and more specifically with the player interaction system 108.

In one embodiment, the player club card reader 116 may be configured to read information indicative of a player identity from any of a variety of player club cards issued by a gaming property associated with the gaming device 100. The player club card reader 116 may also be configured to read gaming property employee cards, smart cards, and the like. Thus, the player club card reader 116 may enable a gaming property to monitor and track player and employee activity each time a player or employee inserts his or her card into the player club card reader 116. Moreover, the information indicative of the player identity read by the player club card reader 116 may be used to personalize game offerings, advertisements, rewards and/or marketing information displayed on the game display 104 or the graphics display 110.

The gaming device 100 may further include a voucher printer (not visible) that prints to and then dispenses vouchers via a voucher slot 120. The voucher printer may comprise any of a variety of printers configured to encode vouchers that may be redeemed by a player. Of course, in other embodiments, other mechanisms for paying out players may be provided, including a coin hopper, a bill dispenser, a device for electronic funds transfer, etc.

During operation, a player may purchase credits on the gaming device 100 in order to play the offered games using any of a variety of payment options (e.g., bills, coins, credit cards, player accounts at the gaming property 100, etc.). Although not illustrated, the gaming device 100 may, for example, include a variety of mechanisms for accepting currency, including a bill acceptor, a credit/debit card acceptor, a coin slot, etc. In another embodiment, the gaming device 100 may enable a player to transfer money from a player's account to the gaming device 100 based at least in part on information indicative of the player's identity read by the player club card reader 116.

For each game play (e.g., a virtual spin of a wheel game), the player may place a wager at the gaming device 100. Upon acceptance of the wager, the wagered amount may be subtracted from the credits associated with the player on the gaming device 100. Depending upon the outcome of the game, the player may then win additional credits or may lose the amount of the wager.

The gaming device 100 may also communicate in the background with one or more gaming servers via a network (not shown). In one embodiment, the gaming device 100 may be required to authenticate itself as well as software executed thereon before exchanging information with a gaming server. In another embodiment, the gaming device 100 may exchange transaction information indicative of monies paid to or received from a player with a gaming server. In another embodiment, the gaming device 100 may receive new software or updated versions of existing software (e.g., new games of chance, or a new version of an operating system) from a gaming server.

In one embodiment, the gaming device 100 may carry out a variety of other tasks in the background. It may be desirable to execute many of these tasks such that a player interacting with the gaming device 100 is unaware of them. In one embodiment, the gaming device 100 may periodically run security checks on software stored in the gaming device 100. For example, the gaming device 100 may execute a hash function on the stored software to generate a hash value that may then be compared against an expected hash value. A difference between the hash values may indicate that the stored software has been corrupted. In another embodiment, the gaming device 100 may store information indicative of the wagers made thereon. Such information may further be associated with a player identity read by the player club card reader 116 and may be periodically forwarded to a gaming server. In yet another embodiment, the gaming device 100 may have a plurality of timers running, which may be used to schedule different tasks.

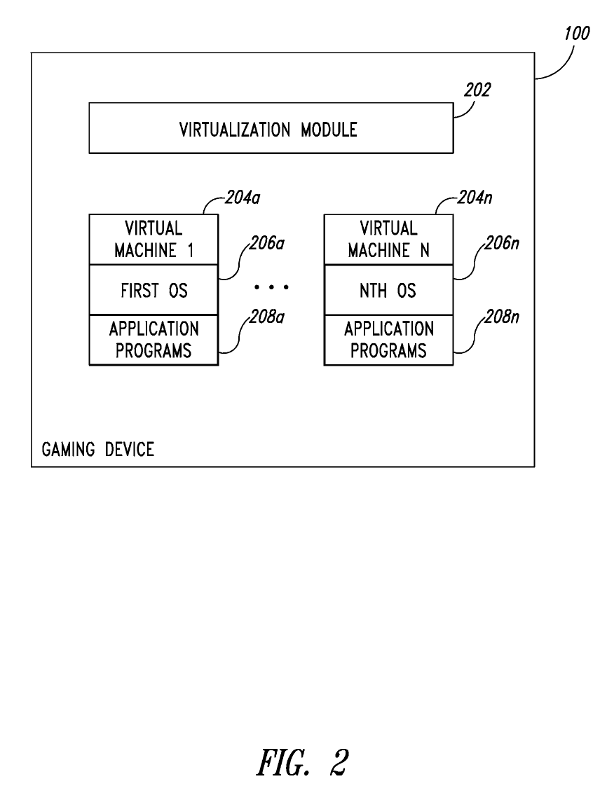

As is schematically illustrated in FIG. 2, a virtualization module 202 of the gaming device 100 may be configured to enable access to resources of the gaming device 100 via a plurality of virtual machines 204a-n (collectively 204). Although only two virtual machines 204a, 204n are illustrated in FIG. 2, it may be understood that three or more virtual machines 204 may be created by the virtualization module 202.

In one embodiment, the virtualization module 202 operates as an abstraction layer residing directly above the hardware of the gaming device 100 and enabling access to hardware resources via the virtual machines 204. For example, VMWare® ESX Server is one example of software that may serve as such a virtualization module. In another embodiment, the virtualization module 202 may comprise software that is executed within an underlying operating system. Such a virtualization module 202 may access the hardware resources of the gaming device 100 via the underlying operating system, while enabling access to the hardware resources via virtual machines 204. For example, the gaming device 100 may execute an underlying Linux-based operating system, within which a virtualization module 202 runs. This virtualization module 202 may then create one or more virtual machines 204 on which, for example, a Microsoft WINDOWS® operating system may run.

Once the virtualization module 202 has partitioned the resources of the gaming device 100 to create the virtual machines 204, any of a variety of operating systems 206a-n (collectively 206) may be executed on respective virtual machines 204. In one embodiment, a number of instances of the same operating system may be executed on the virtual machines 204. In another embodiment, a number of different operating systems 206 compatible with the hardware resources of the gaming device 100 may be executed on the virtual machines 204.

Of course, the operating systems 206 may comprise any appropriate operating system, including: Microsoft WINDOWS® operating systems (e.g., XP, Vista, Server 2003, CE, etc.), Linux-based or other UNIX-compatible operating systems, Apple® brand operating systems, Sun Microsystem's SOLARIS™ operating system, etc. In one embodiment, the operating systems 206 executed on the virtual machines 204 may be selected based at least in part on the particular functionality implemented within the gaming device 100. For example, at least one operating system 206 configured to meet real-time constraints may be executed on a corresponding virtual machine 204 in order to ensure that certain functions of the gaming device 100 may be executed in real-time. As another example, at least one operating system 206 having a broad code base and plentiful third party applications may be executed on another virtual machine 204 in order to improve development time for the gaming device 100. As yet another example, at least one operating system 206 offering improved security may be executed on a virtual machine 204 in order to keep certain applications and data secure on the gaming device 100. Different implementations and environments may make the use of different operating systems 206 more or less desirable within the gaming device 100.

As used herein, the term “real-time constraint” is a general term referring to a requirement that an application or operating system respond in accordance with relatively tight operational deadlines from event to system response. By contrast, an application or operating system without real-time constraints is typically not associated with particular deadlines, even if fast response or high performance is desirable.

Of course, a variety of application programs 208a-n (collectively 208) may be executed in the operating systems 206. These application programs 208 may enable a number of different functions for the gaming device 100, including any of the functions described above with respect to FIG. 1. As used herein, the term “application program” or “application” is a general term referring to any computer-executable code configured to provide some functionality. For example, an application program may comprise a driver or an application embedded within an operating system.

The operating systems 206 and the application programs 208 may be logically divided among the virtual machines 204 in a variety of ways. In one embodiment, a first virtual machine 204 may host an operating system 206 having real-time capabilities in which at least one real-time application 208 having a real-time constraint is executed. A second virtual machine 204 may then host an operating system 206 having a broad code base and plentiful third party applications in which a number of interactive and graphics-intensive applications 208 may be executed, including at least one game of chance.

In another embodiment, a first virtual machine 204 may host a relatively secure operating system 206 in which a plurality of application programs 208 requiring a secure environment may be executed. Such application programs 208 may include applications that run security checks on software stored in the gaming device 100, applications that authenticate the gaming device 100 with gaming servers, applications that monitor and track transaction information, etc. Simultaneously, a second virtual machine 204 may host a relatively insecure operating system 206 offering greater interactivity in which a plurality of application programs 208 may be executed, including at least one game of chance.

In yet another embodiment, a first virtual machine 204 may host a first operating system 206 in which a plurality of application programs 208 providing communications capabilities may be executed. Such application programs 208 may include a number of applications that interact with one or more gaming servers. Simultaneously, a second virtual machine 204 may host a second operating system 206 in which a plurality of application programs 208 that do not provide communications functionality beyond the gaming device 100 may be executed. Thus, those application programs enabling communications within a secure network may be kept isolated from other application programs.

In yet another embodiment, a first virtual machine 204 may host a first operating system 206 in which a plurality of application programs 208 providing financial transaction-related capabilities may be executed. Such application programs 208 may include a number of applications that track currency inserted into or other credits transferred into or out from the gaming device 100. Simultaneously, a second virtual machine 204 may host a second operating system 206 in which a plurality of application programs 208 that do not provide such financial transaction-related functionality may be executed. Thus, those application programs enabling access to financial transactions may be kept isolated from other application programs.

In still another embodiment, a first virtual machine 204 may host a first operating system 206 in which a plurality of application programs 208 running in the background may be executed. Simultaneously, a second virtual machine 204 may host a second operating system 206 in which a plurality of application programs 208 that enable player interaction may be executed.

In other embodiments, of course, other logical divisions may be made among the virtual machines 204 to keep certain operating systems 206 and application programs 208 logically separated.

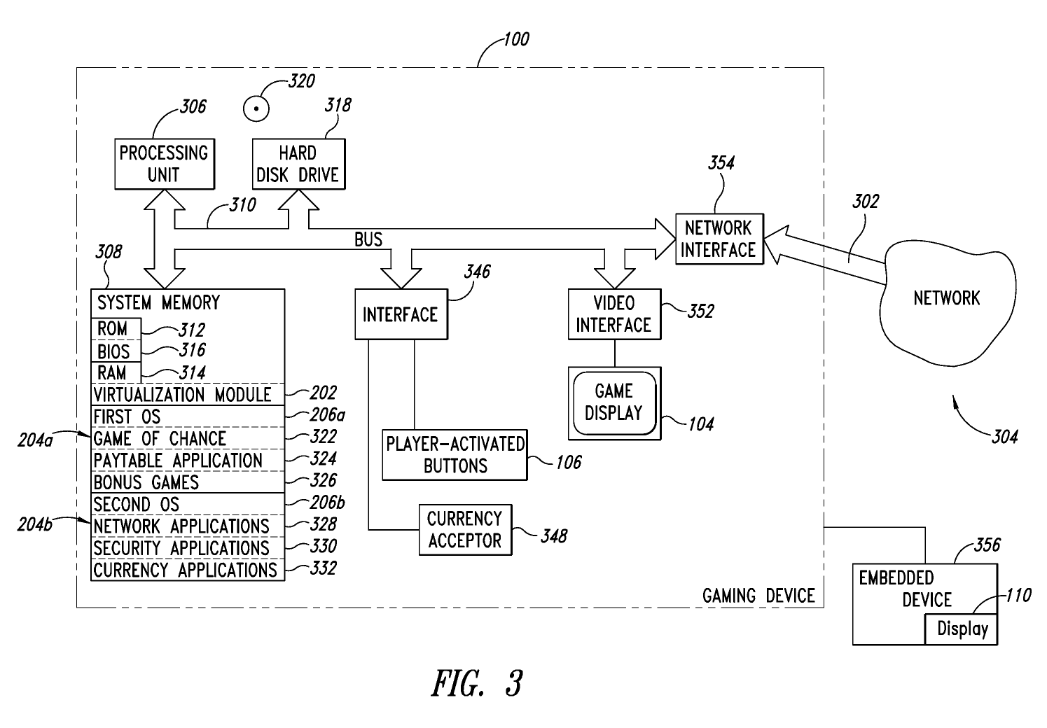

With reference to FIG. 3, the internal structure of the gaming device 100 may be described in greater detail. Although not required, the embodiments will be described in the general context of computer-executable instructions, such as program application modules, objects, or macros being executed by a computer. The embodiments can be practiced in distributed computing environments where tasks or modules are performed by remote processing devices, which are linked through a communications network. In a distributed computing environment, program modules may be located in both local and remote memory storage devices.

FIG. 3 is a schematic view of the gaming device 100. The gaming device 100 may be coupled by at least one communication channel/logical connection 302 to a network 304. Thus, in one embodiment, the gaming device 100 may be communicatively coupled with other gaming devices and/or with one or more gaming servers within a gaming property.

The gaming device 100 may have an internal configuration similar to that of a conventional PC, which includes a processing unit 306, a system memory 308 and a system bus 310 that couples various system components including the system memory 308 to the processing unit 306.

The processing unit 206 may be any logic processing unit, such as one or more central processing units (CPUs), digital signal processors (DSPs), application-specific integrated circuits (ASICs), field programmable gate arrays (FPGAs), etc. Indeed, the processing unit 306 will at times be referred to in the singular herein, but this is not intended to limit the embodiments to a single processor or processing core. In particular, the processing unit 306 may comprise a plurality of processors coupled together via the system bus 310. In another embodiment, the processing unit 306 may comprise a first core and a second core packaged in a single integrated circuit. In another embodiment, the processing unit 306 may comprise even more cores packaged in a single integrated circuit. As will be described in greater detail below, in one embodiment, the virtualization module 202 may partition the processing resources of the processing unit 306 in accordance with the pre-existing hardware divisions between individual processors or cores. Of course, in other embodiments, the virtualization module 202 may simply partition the processing resources of a single processor for use by a plurality of virtual machines 204. Non-limiting examples of commercially available processing units 306 include, but are not limited to, 80x86 or Core series microprocessors from Intel Corporation, PowerPC microprocessors from IBM, Sparc microprocessors from Sun Microsystems, Inc., or PA-RISC series microprocessors from Hewlett-Packard Company.

Unless described otherwise, the construction and operation of the various blocks shown in FIG. 3 are of conventional design. As a result, such blocks need not be described in further detail herein, as they will be understood by those skilled in the relevant art.

The system bus 310 can employ any known bus structures or architectures, including a memory bus with memory controller, a peripheral bus, and a local bus. The system memory 308 includes read-only memory (“ROM”) 312 and random access memory (“RAM”) 314. A basic input/output system (“BIOS”) 316, which can form part of the ROM 312, contains basic routines that help transfer information between elements within the gaming device 100, such as during start-up.

The gaming device 100 may also include a hard disk drive 318 for reading from and writing to a hard disk 320. The hard disk drive 318 may communicate with the processing unit 306 via the system bus 310. The hard disk drive 318 may also include an interface or controller (not shown) coupled between it and the system bus 310, as is known by those skilled in the relevant art. The hard disk drive 318 provides nonvolatile storage for computer-readable instructions, data structures, program modules and other data for the gaming device 100. Although the depicted gaming device 100 employs a hard disk 320, those skilled in the relevant art will appreciate that other types of computer-readable media that can store data accessible by a computer may be employed, such as magnetic cassettes, flash memory cards, RAMs, ROMs, smart cards, optical disks, etc.

Program modules can be stored in the system memory 308, such as the virtualization module 202, a first operating system 206a and a second operating system 206b. In one embodiment, as described above, the virtualization module 202 may be configured to create a first virtual machine 204a and a second virtual machine 204b. The hardware resources of the gaming device 100 (including many of the resources pictured in FIG. 3) may then be accessed via these virtual machines 204. In one embodiment, the first operating system 206a is executable on the first virtual machine 204a, and the second operating system 206b is executable on the second virtual machine 204b. As illustrated, a game of chance 322 may be executable in the first operating system 206a, and at least one real-time application that is subject to a real-time constraint may be executable in the second operating system 206b.

In one embodiment, the first operating system 206a may comprise a Microsoft WINDOWS® operating system, such as Microsoft WINDOWS® XP. As is well known in the art, this widely used operating system provides a broad code base and plentiful third party applications. Thus, by utilizing this operating system, it may be relatively easy to find third party applications for providing particular functionality for the gaming device 100. Moreover, the first operating system 206a may be associated with programming utilities that facilitate the development of graphics-intensive applications.

A number of applications may be executed in the first operating system 206a. In one embodiment, at least one game of chance 322 is executed in the first operating system 206a. The game of chance 322 may be relatively graphics-intensive in one embodiment. In another embodiment, a paytable application 324 that generates payout amounts corresponding to particular outcomes of the game of chance 322 may be executed in the first operating system 206a. In yet another embodiment, one or more bonus games 326 may be executed in the first operating system 206a.

The second operating system 206b may comprise an operating system offering real-time capabilities. For example, the second operating system 206b may comprise a Linux-based operating system that has been modified to include real-time capabilities, such as the ALPHA OS™ by Bally Technologies, Inc.

Any of a number of real-time applications subject to real-time constraints as well as other applications may be executed in the second operating system 206b. In one embodiment, network applications 328 configured to enable communication between the gaming device 100 and at least one gaming server may be executed in the second operating system 206b. Such network applications 328 may require real-time responses to network inquiries. In another embodiment, security applications 330 that validate software stored on the gaming device 100 may also be executed in the second operating system 206b. In yet another embodiment, currency applications 332 that receive and process information indicative of currency inserted into the gaming device 100 (e.g., via currency acceptor 348) may be executed in the second operating system 206b. Such currency applications 332 may also be subject to real-time constraints when responding to these financial transactions.

By partitioning the resources of the gaming device 100 to create the first virtual machine 204a and the second virtual machine 204b, the virtualization module 202 may provide the operating systems 206a, 206b with access to a guaranteed subset of the resources of the gaming device 100. Thus, for example, even if the first operating system 206a is executing a particularly graphics-intensive game of chance 322, the bandwidth and resources available to the real-time applications running in the second operating system 206b will be substantially unaffected. Moreover, applications executing in the second operating system 206b that should not be accessible to players of the gaming devices 100 may be kept isolated from the interactive applications provided in the first operating system 206a.

In one embodiment, the virtualization module 202 may partition resources of the gaming device 100 by partitioning processing resources of the processing unit 306. For example, in order to further optimize utilization of the resources of a gaming device having multiple cores, the virtualization module 202 may partition the resources such that processing resources of a first core are allocated for use by the first virtual machine 204a, and processing resources of a second core are allocated for use by the second virtual machine 204b. In another embodiment, in order to further optimize utilization of the resources of a gaming device having multiple processors, the virtualization module 202 may partition the resources such that processing resources of a first processor are allocated for use by the first virtual machine 204a, and processing resources of a second processor are allocated for use by the second virtual machine 204b.

While shown in FIG. 3 as being stored in the system memory 308, the virtualization module 202, operating systems 206, and application programs 322-332 can be stored on the hard disk 320 of the hard disk drive 318.

A player can interact with the gaming device 100 through user interfaces such as the player-activated buttons 106. Other user interfaces for receiving user input can include a touch-sensitive display, the touch-sensitive bezel 112, joystick, game pad, tablet, etc. These and other user interfaces may be connected to the processing unit 306 through an interface 346 such as a universal serial bus (“USB”) interface that couples to the system bus 310, although other interfaces such as a parallel port, a game port or a wireless interface or a serial port may be used.

The interface 346 may further be coupled to a currency acceptor 348 configured to accept currency from a player. In one embodiment, the currency acceptor 348 may include one or more coin slots, bill acceptors, etc. In another embodiment, the gaming device 100 may include a card slot for receiving a financial card issued by a financial institution (e.g., a credit/debit card), via which credits may be purchased.

In one embodiment, as illustrated, an embedded device 356 may also be coupled to the gaming device 100 via an interface (e.g., via the interface 346). The embedded device 356 may comprise a logically separate computing device including its own processing unit, memory, bus, etc. This embedded device 356 may have relatively limited computational resources and may run an operating system having a relatively small footprint, such as Microsoft WINDOWS® CE. In one embodiment, the embedded device 356 may provide the functionality described above with regards to the player interaction system 108. In particular, the embedded device 356 may be communicatively coupled to the player club card reader 116 and may control the graphics display 110. As described above, the graphics display 110 may display marketing, advertising, rewards and other information to a player.

The game display 104 and other display devices may be coupled to the system bus 310 via a video interface 352, such as a video adapter.

The gaming device 100 may operate in a networked environment using one or more logical connections 302 to communicate with one or more remote computers, gaming servers and/or other gaming devices through the network 304. These logical connections may facilitate any known method of permitting computers to communicate, such as through one or more LANs and/or WANs, such as the Internet. Such networking environments are well known in wired and wireless enterprise-wide computer networks, intranets, extranets, and the Internet.

In one embodiment, the network interface 354 (communicatively linked to the system bus 310) may be used for establishing communications over the logical connection 302. In a networked environment, certain software modules can be stored outside of the gaming device 100 (not shown). Those skilled in the relevant art will recognize that the network connections shown in FIG. 3 are only some examples of ways of establishing communications between computing devices, and other connections may be used.

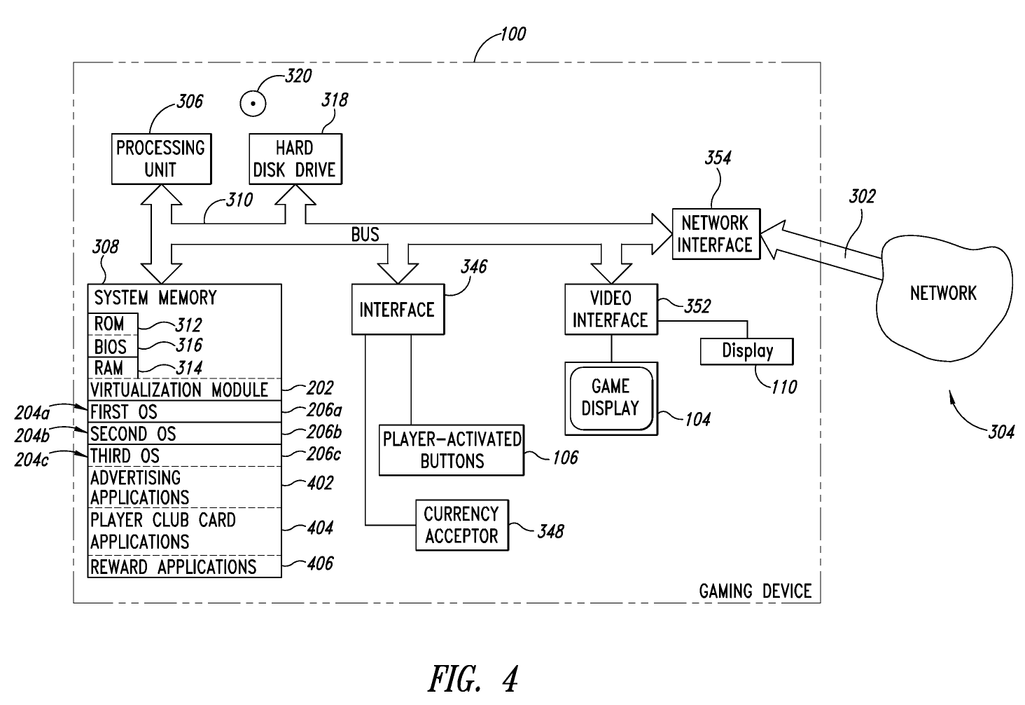

With reference to FIG. 4, the internal structure of the gaming device 100 is described with reference to another embodiment. The above description with reference to FIG. 3 applies equally to the similarly numbered elements of FIG. 4, except with regards to those elements discussed in detail below.

In one embodiment, a third virtual machine 204c is created by the virtualization module 202. As illustrated, the system memory 308 may include a third operating system 206c executable on the third virtual machine 204c, and a number of applications 402-406 may be executed in the third operating system 206c. For example, at least one advertising application 402 configured to display at least one advertisement on the graphics display 110 may be executable in the third operating system 206c.

In one embodiment, the third operating system 206c may comprise an embedded operating system similar to the relatively small operating system used in the embedded device 356 (e.g., Microsoft WINDOWS® CE). By utilizing such an operating system, it may be possible to eliminate many of the computational resources of the embedded device 356 and replace them with the partitioned resources of the gaming device 100.

In one embodiment, a player club card application 404 may be executable in the third operating system 206c. The player club card application 404 may be configured to receive and process information indicative of a player identity read by the player club card reader 116. This player identity information may then be used by other applications executing in the third operating system 206c. For example, in one embodiment the at least one advertisement displayed on the graphics display 110 may be based at least in part on the player identity information. In another embodiment, at least one rewards application 406 configured to display at least one reward on the graphics display 110 may be executed in the third operating system 206c. Again, the at least one reward may be generated based at least in part on the player identity information.

Other operating systems and application programs may be executed on the gaming device 100 in other embodiments.

### Description of an Exemplary Method for Enabling Access to Resources of a Gaming Device

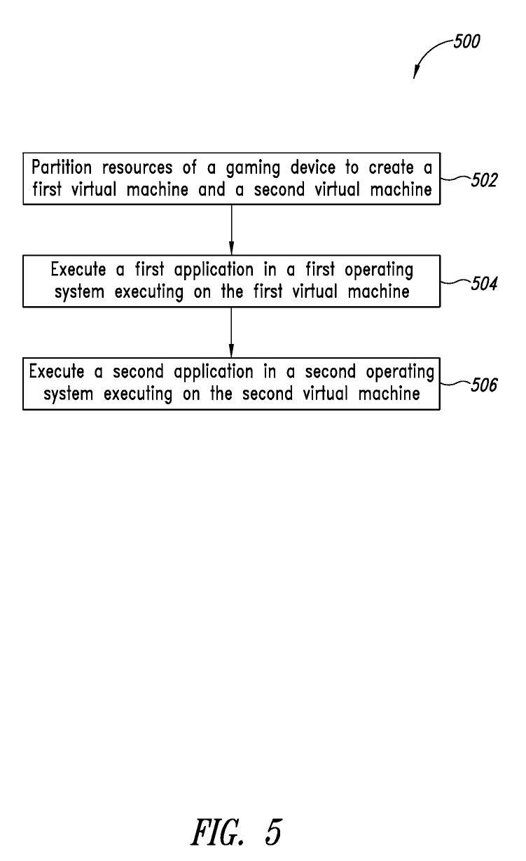

FIG. 5 illustrates a flow diagram for a method 500 of enabling access to resources of a gaming device, according to one embodiment. This method 500 will be discussed in the context of the gaming device 100 of FIGS. 1-4. However, it may be understood that the acts disclosed herein may be executed in a variety of different gaming devices, in accordance with the described method.

The method begins at 502, when resources of a gaming device 100 are partitioned to create a first virtual machine 204a and a second virtual machine 204b. As described above, a variety of hardware resources of the gaming device 100 may be partitioned. In one embodiment, such resources may include RAM and other computer-readable memory resources, processing resources, graphics card resources, network bandwidth resources, etc.

The first virtual machine 204a and the second virtual machine 204b may each act as a distinct logical computing system. This may allow operating systems and applications running on these two virtual machines 204a, 204b to operate as though they are the sole programs accessing a given hardware resource. In other embodiments, of course, more than two virtual machines 204 may be created during this partitioning act.

In one embodiment, a virtualization module may perform the above partitioning act. This virtualization module may comprise any computer-executable code configured to provide virtualization. In one embodiment, the virtualization module may comprise firmware integrated with hardware resources of the gaming device 100 and executable thereon. In another embodiment, the virtualization module may comprise software that is loadable upon a boot operation into RAM of the gaming device 100 for execution by at least one processor of the gaming device 100. In yet another embodiment, the virtualization module may comprise software that may be executed within an operating system executing on the gaming device 100. For example, the virtualization module may comprise portions of code embedded within an operating system executing on the gaming device.

At 504, a first application is executed in a first operating system 206a executing on the first virtual machine 204a, and, at 506, a second application is executed in a second operating system 206b executing on the second virtual machine 204b. As illustrated in FIG. 3, a game of chance 322 may be executable in the first operating system 206a, and at least one real-time application that is subject to a real-time constraint may be executable in the second operating system 206b. In other embodiments, of course, other applications and other operating systems may be executed within the first and second virtual machines 204, as described in greater detail above.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more programs executed by one or more processors, as one or more programs executed by one or more controllers (e.g., microcontrollers), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information can be stored on any computer readable medium for use by or in connection with any processor-related system or method. In the context of this document, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any means that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a nonexhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), and a portable compact disc read-only memory (CDROM). Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

The various embodiments described above can be combined to provide further embodiments. From the foregoing it will be appreciated that, although specific embodiments have been described herein for purposes of illustration, various modifications may be made without deviating from the spirit and scope of the teachings. Accordingly, the claims are not limited by the disclosed embodiments.

We claim:

1. A gaming device comprising:
a housing;
a game display carried by the housing;
a user interface carried by the housing and configured to receive user input from a player;
a first processor that executes instructions; and
a computer-readable memory having stored thereon:
a virtualization module configured to enable access to resources of the gaming device via a first virtual machine and a second virtual machine;
a first operating system executable on the first virtual machine;
a game of chance executable in the first operating system;
a second operating system executable on the second virtual machine; and
a real-time application executable in the second operating system, the real-time application being subject to a real-time constraint.

2. The gaming device of claim 1, wherein the first operating system and the second operating system comprise different operating systems.

3. The gaming device of claim 1, wherein the real-time application comprises a network application configured to enable communication between the gaming device and at least one gaming server.

4. The gaming device of claim 1, wherein the real-time application comprises a currency application operable to receive and process information indicative of currency inserted into the gaming device.

5. The gaming device of claim 1, wherein the virtualization module is further configured such that the first virtual machine and the second virtual machine utilize processing resources of the first processor substantially concurrently.

6. The gaming device of claim 5, wherein the first processor includes a first core and a second core packaged in a single integrated circuit, and wherein the virtualization module is further configured such that the first virtual machine utilizes processing resources of the first core and the second virtual machine utilizes processing resources of the second core.

7. The gaming device of claim 1, further comprising a second processor that executes instructions, wherein the virtualization module is further configured such that the first virtual machine utilizes processing resources of the first processor and the second virtual machine utilizes processing resources of the second processor.

8. The gaming device of claim 1, further comprising a player club card reader configured to read information indicative of a player identity from a player club card issued by a gaming property, wherein the virtualization module is further configured to enable access to the resources of the gaming device via a third virtual machine, and wherein the computer-readable memory further has stored thereon a third operating system executable on the third virtual machine, and a player club card application executable in the third operating system, the player club card application configured to receive and process the information indicative of the player identity read by the player club card reader.

9. The gaming device of claim 8, further comprising a secondary display, wherein the computer-readable memory further has stored thereon an advertising application executable in the third operating system, the advertising application configured to display at least one advertisement on the secondary display.

10. The gaming device of claim 9, wherein the at least one advertisement is displayed based at least in part on the information indicative of the player identity processed by the player club card application.

11. The gaming device of claim 8, further comprising a secondary display, wherein the computer-readable memory further has stored thereon a rewards application executable in the third operating system, the rewards application configured to display at least one reward on the secondary display, the at least one reward based at least in part on the information indicative of the player identity processed by the player club card application.

12. A gaming device comprising:
a housing;
a game display carried by the housing;
a user interface carried by the housing and configured to receive user input from a player;
at least one processor that executes instructions; and
a computer-readable memory that stores instructions that cause the at least one processor to enable access to resources of the gaming device, by:
partitioning the resources of the gaming device to create a first virtual machine and a second virtual machine;
executing a game of chance in a first operating system executing on the first virtual machine; and
executing a real-time application subject to a real-time constraint in a second operating system executing on the second virtual machine.

13. The gaming device of claim 12, wherein the first operating system and the second operating system comprise different operating systems.

14. The gaming device of claim 12, wherein executing the real-time application includes executing a network application that enables communication between the gaming device and at least one gaming server.

15. The gaming device of claim 12, wherein executing the real-time application includes executing a currency application that receives and processes information indicative of currency inserted into the gaming device.

16. The gaming device of claim 12, wherein partitioning the resources of the gaming device includes partitioning processing resources of the at least one processor.

17. The gaming device of claim 16, wherein the at least one processor includes a first core and a second core packaged in a single integrated circuit, and wherein partitioning the resources of the gaming device includes allocating processing resources of the first core for use by the first virtual machine, and allocating processing resources of the second core for use by the second virtual machine.

18. The gaming device of claim 16, wherein the at least one processor includes a first processor and a second processor, and wherein partitioning the resources of the gaming device includes allocating processing resources of the first processor for use by the first virtual machine, and allocating processing resources of the second processor for use by the second virtual machine.

19. A computer-implemented method of enabling access to resources of a gaming device, the method comprising:
partitioning the resources of the gaming device to create a first virtual machine and a second virtual machine;
executing a game of chance in a first operating system executing on the first virtual machine; and
executing a real-time application subject to a real-time constraint in a second operating system executing on the second virtual machine.

20. The method of claim 19, wherein the first operating system and the second operating system comprise different operating systems.

21. The method of claim 19, wherein executing the real-time application includes executing a network application that enables communication between the gaming device and at least one gaming server.

22. The method of claim 19, wherein executing the real-time application includes executing a currency application that receives and processes information indicative of currency inserted into the gaming device.

23. The method of claim 19, wherein partitioning the resources of the gaming device includes partitioning processing resources of at least one processor of the gaming device

24. The method of claim 23, wherein the at least one processor includes a first core and a second core packaged in a single integrated circuit, and wherein partitioning the resources of the gaming device includes allocating processing resources of the first core for use by the first virtual machine, and allocating processing resources of the second core for use by the second virtual machine.

25. The method of claim 23, wherein the at least one processor includes a first processor and a second processor, and wherein partitioning the resources of the gaming device includes allocating processing resources of the first processor for use by the first virtual machine, and allocating processing resources of the second processor for use by the second virtual machine.

26. A computer-readable medium that stores instructions that cause at least one processor to enable access to resources of a gaming device, by:
partitioning the resources of the gaming device to create a first virtual machine and a second virtual machine;
executing a game of chance in a first operating system executing on the first virtual machine; and
executing a real-time application subject to a real-time constraint in a second operating system executing on the second virtual machine.

27. The computer-readable medium of claim 26, wherein the first operating system and the second operating system comprise different operating systems.

28. The computer-readable medium of claim 26, wherein executing the real-time application includes executing a network application that enables communication between the gaming device and at least one gaming server.

29. The computer-readable medium of claim 26, wherein executing the real-time application includes executing a currency application that receives and processes information indicative of currency inserted into the gaming device.

30. The computer-readable medium of claim 26, wherein partitioning the resources of the gaming device includes partitioning processing resources of the at least one processor.

31. The computer-readable medium of claim 30, wherein the at least one processor includes a first core and a second core packaged in a single integrated circuit, and wherein partitioning the resources of the gaming device includes allocating processing resources of the first core for use by the first virtual machine, and allocating processing resources of the second core for use by the second virtual machine.

32. The computer-readable medium of claim 30, wherein the at least one processor includes a first processor and a second processor, and wherein partitioning the resources of the gaming device includes allocating processing resources of the first processor for use by the first virtual machine, and allocating processing resources of the second processor for use by the second virtual machine.
